(19) United States
(12) Patent Application Publication
(10) Pub. No.: US 2025/0226578 A1
(43) Pub. Date: Jul. 10, 2025

(54) PHASE SHIFTER AND ANTENNA DEVICE COMPRISING SAME

(71) Applicant: KMW INC., Hwaseong-si (KR)

(72) Inventors: Duk Yong KIM, Yongin-si (KR); Young Chan MOON, Suwon-si (KR); Sung Hwan SO, Hwaseong-si (KR); Oh Seog CHOI, Hwaseong-si (KR); Seong Man KANG, Hwaseong-si (KR); Yong Won SEO, Hwaseong-si (KR)

(73) Assignee: KMW INC., Hwaseong-si (KR)

(21) Appl. No.: 19/088,910

(22) Filed: Mar. 24, 2025

Related U.S. Application Data
(63) Continuation of application No. PCT/KR2023/014806, filed on Sep. 26, 2023.

(30) Foreign Application Priority Data
Sep. 28, 2022 (KR) 10-2022-0123170

(51) Int. Cl. H01Q 3/36; H01Q 3/04

(52) U.S. Cl. CPC H01Q 3/36; H01Q 3/04

(57) ABSTRACT

The present invention relates to a phase shifter and an antenna device comprising same. In particular, the present invention provides the advantage of preventing physical interference between antenna elements between adjacent columns and enabling slim manufacturing of products, by comprising: a front feed strip line which is branched and electrically connected so as to enable dual polarized beam output to a plurality of radiating element modules disposed on the front of an antenna board assembly forming a plurality of antenna sub-arrays and additional antenna sub-arrays; a fixed substrate unit which is disposed on the front of the antenna board assembly, has a variable contact pattern that connects branch points of the front feed strip line and changes a physical transmission length to a first polarization side and a second polarization side of the radiating element modules; and a movable substrate unit which has a conductive terminal pattern that moves and makes contact with the variable contact pattern of the fixed substrate unit.

### TECHNICAL FIELD

The present disclosure relates to a phase shifter and an antenna apparatus including the same and to a phase shifter and an antenna apparatus including the same, which enable an antenna apparatus product to be easily slimmed and manufactured and can manufacture an antenna apparatus product in various manufacturing ways.

### BACKGROUND ART

In a mobile communication system, a fixed type antenna was first used as a base station antenna. However, recently, a vertical beam tilt control antenna capable of vertical (and/or horizontal) beam tilting is supplied due to its many advantages. In such a vertical beam tilt control antenna, a beam tilt method may be basically divided into a mechanical beam tilt method and an electrical beam tilt method.

In general, the mechanical beam tilt method is a method based on a manual or power-driven bracket structure that is provided at a portion combined with a support pole in an antenna. The vertical beam tilt of the antenna is enabled because the installation slope of the antenna is changed by an operation of the bracket structure. The electrical beam tilt method is a method based on a multi-line phase shifter (MLPS), and is a method that enables electrical vertical beam tilting by changing a difference between the phases of signals supplied to antenna radiation elements that are vertically arranged. A technology related to such vertical beam tilting may include an example disclosed in U.S. Pat. No. 6,864,837 (title: VERTICAL ELECTRICAL DOWNTILT ANTENNA, inventors: two persons in addition to Donald L. Runyon, and issue date: Mar. 8, 2005) the application of which was applied for by “EMS Technologies, INC.”

For such electrical vertical beam tilting, the MLPS is essentially provided. In general, the MLPS is used in various fields of an RF analog signal processing stage in order to perform a phase modification function in addition to beam control of a phase array antenna, in particular. The principle of the MLPS is to generate a phase difference between an input signal and an output signal by properly delaying the input signal. The MLPS may be implemented by the physical length of simply differentiating a transmission line and by differentiating a signal transfer rate within a transmission line in various ways. Such an MLPS is commonly used as the structure of an MLPS which can change a degree of phase shift by changing a length transmission line, for example.

In particular, recently, a mobile communication system requires a technology in which the phases of radiation elements of a phase array antenna are harmoniously changed in order to adjust coverage of a base station by adjusting the vertical beam angle of a phase array antenna of the base station. In accordance with such a need, MLPSs having various structures are developed and supplied. In particular, such an MLPS may have a structure for dividing an input signal into multiple output signals and properly adjusting a difference between the phases of the output signals. A technology relating to such an MLPS for vertical beam tilt may include an example disclosed in U.S. Pat. No. 6,831,602 (title: LOW COST TROMBONE LINE BEAMFORMER, inventors: two persons in addition to William E. Mckinzie, III, and issue date: Dec. 14, 2004) the application of which was applied for by “Etenna Corporation.”

However, such an MLPS was mainly developed to merely improve performance, which change the structure of a corresponding MLPS itself or the phase of a processing signal, but was slightly insufficient in research in which the structure of an antenna where a corresponding MLPS is installed like a phase array antenna is considered. Accordingly, in line with the need of research and development of an MLPS having an improved performance and structure, the applicant of the present disclosure filed an application for MULTI LINE PHASE SHIFTER FOR ADJUSTABLE VERTICAL BEAM TILT ANTENNA (Korean Patent Application No. 10-2009-0040978), and Korean Patent No. 10-1567882 (hereinafter referred to as “the applicant's issued patent”) was issued to the applicant on Nov. 4, 2015.

FIG. 1 is a circuit diagram of the applicant's issued patent (refer to FIG. 7), and is a concept view illustrating an arrangement relation of a conventional phase shifter.

In this case, the applicant's issued patent also has a problem as follows. As illustrated in FIGS. 1 (a) and (a-1), multiple phase-variable patterns are formed on a surface that faces the fixed substrate 14 of the moving substrate 12 of a phase shifter 1. The phase-variable patterns need to be patterned and printed so that an input signal is divided and input to a first polarized side 12A on one side of the phase shifter and a second polarized side 12B on the other side thereof. Accordingly, the width of the moving substrate 12 is further increased because the printing range of the phase-variable patterns is excessively occupied in the width direction W of the moving substrate 12. Furthermore, there is a problem in that the phase-variable patterns s may interfere with each other between one-side column C1 in which antenna elements 35A have already been arranged at a predetermined separation distance and the other-side column C2.

In order to solve such a problem, as illustrated in FIGS. 1 (b) and (b-1), after the moving substrates 12-1 and 12-2 of a phase shifter, which correspond to the first polarized side 12A and the second polarized side 12B, are divided, the moving substrates may be disposed in a vertical direction (i.e., the forward and backward depth direction D of an antenna apparatus) and movably installed. However, in this case, there is a problem in that the slim manufacturing of a product is restricted because the forward and backward thickness of the antenna apparatus is increased.

### DISCLOSURE

### Technical Problem

The present disclosure has been contrived to solve the technical problems, and an object of the present disclosure is to provide a phase shifter and the antenna apparatus including the same, which do not increase an installation space in the depth direction of the antenna apparatus and can be manufactured in various manufacturing was.

Furthermore, another object of the present disclosure is to provide a phase shifter and the antenna apparatus including the same, which can improve the gain of an antenna and also minimize interference between the beams of the columns of radiation elements because a beam having a narrower width can be radiated.

Objects of the present disclosure are not limited to the aforementioned objects, and the other objects not described above may be evidently understood from the following description by those skilled in the art.

### Technical Solution

A phase shifter according to an embodiment of the present disclosure includes a front feed strip line branched to enable a beam output of dual polarization and electrically connected to multiple radiation element modules that form multiple antenna sub-arrays and multiple additional antenna sub-arrays and that are disposed on a front surface of an antenna board assembly, a fixed substrate part disposed on the front surface of the antenna board assembly and including a variable contact point pattern that connects a branch point of the front feed strip line and that changes a physical transmission length toward a first polarized side and second polarized side of the radiation element module, and a moving substrate part in which an electrical conduction terminal pattern that is brought into contact with the variable contact point pattern of the fixed substrate part while being moved has been formed.

In this case, the multiple fixed substrate parts may be provided to be spaced apart from each other in one column in which the multiple antenna sub-arrays and the multiple additional antenna sub-arrays are formed on the front surface of the antenna board assembly in up and down directions. The moving substrate part may be provided to have a number corresponding to the fixed substrate parts.

Furthermore, the front feed strip line and the variable contact point pattern of the fixed substrate part may be integrally formed in the antenna board assembly.

Furthermore, the front feed strip line may be formed separately from the fixed substrate part and may be formed on the front surface of the antenna board assembly made of a PCB material by patterning and printing the front feed strip line.

Furthermore, the fixed substrate part may be provided in a PCB form in which the fixed substrate part is made of a PCB material different from that of the antenna board assembly. The variable contact point pattern may be formed on a front surface of the fixed substrate part provided in the PCB form by patterning and printing the variable contact point pattern.

Furthermore, the antenna board assembly may include a reflecting panel configured to forward reflect antenna beams radiated from the multiple antenna sub-arrays and the multiple additional antenna sub-arrays, a rear panel stacked and combined with a back surface of the reflecting panel, and a front panel stacked and combined with a front surface of the reflecting panel. The front feed strip line may be provided in a terminal strip form in which the front feed strip line is fixed to the front panel of the antenna board assembly, which is made of a non-conductive material.

Furthermore, the front feed strip line may be arranged in a strip line installation slit processed in the front panel in a slit shape.

Furthermore, the radiation element module may be provided to be electrically connected to a front of the RF filter. The multiple antenna sub-arrays and the multiple additional antenna sub-arrays may be arranged to embody antenna beamforming by constructing a predetermined number of RF chains. A phase value may be shifted by changing a length ratio of physical transmission lines of the multiple antenna sub-arrays and the multiple additional antenna sub-arrays at a predetermined ratio.

Furthermore, the electrical conduction terminal pattern of the moving substrate part may embody a linear phase distribution according to the predetermined ratio with respect to an identical reference phase surface by radiating beams by differently shifting phase values of the multiple antenna sub-arrays and the additional antenna sub-array in a transmission line that constitutes any one of an input stage of each of the RF chains and the branched two output stages, by an operation of being moved and brought into contact with the variable contact point pattern of the fixed substrate part.

An antenna apparatus according to an embodiment of the present disclosure includes the phase shifter.

### Advantageous Effects

The phase shifter and the antenna apparatus including the same according to embodiments of the present disclosure have effects in that an installation space is minimized in the depth direction of the antenna apparatus and the reliability of a product is improved because phases for the polarization-side transmission lines on both left and right sides can be shifted at the same time.

### DESCRIPTION OF DRAWINGS

FIG. 1 is a circuit diagram of the applicant's issued patent (refer to FIG. 7) and is a concept view illustrating an arrangement relation of a conventional phase shifter.

FIG. 2 is a concept view including a common circuit diagram of a phase shifter according to an embodiment of the present disclosure.

FIG. 3 is a perspective view illustrating a form in which an antenna apparatus according to an embodiment of the present disclosure has been installed in a support pole.

FIG. 4 is an exploded perspective view of FIG. 3.

FIG. 5 is a perspective view illustrating an appearance of a phase shifter and an antenna apparatus including the same according to embodiments of the present disclosure.

FIG. 6 is an exploded perspective view of the state in which a radome panel, among the components of FIG. 5, has been separated.

FIG. 7 is an exploded perspective view illustrating the state in which the radome panel and an antenna housing part, among the components of FIG. 5, have been separated.

FIGS. 8A and 8B are an exploded perspective views of exploded front part and rear parts of a radiation element module.

FIG. 9 is an exploded perspective view illustrating the state in which one RF chain, among the components of FIG. 6, has been separated.

FIG. 10 is a front view illustrating the radiation element module of FIG. 8A.

FIG. 11 is an exploded perspective view illustrating the state in which one RF chain included in the radiation element module of FIG. 6 and the phase shifter have been separated.

FIG. 12 is an exploded perspective view of an antenna board assembly and a feed strip line combined therewith, among the components of the radiation element module of FIGS. 8A and 8B.

FIG. 13 is a cross-sectional view for describing an operation relation of the phase shifter, among the components of the phase shifter and the antenna apparatus including the same according to embodiments of the present disclosure.

FIG. 14 is a perspective view illustrating a phase shifter according to an embodiment of the present disclosure.

FIG. 15 is an exploded perspective view of FIG. 14.

FIG. 16 is a perspective view illustrating a radiation element module of a single column.

FIG. 17 is an exploded perspective view of FIG. 16.

FIG. 18 is a front view of FIG. 16, and is a front view and partial projection view illustrating the state in which a fixed substrate part and a moving substrate part have been exploded.

FIG. 19 is a circuit diagram and phase difference diagram for describing the principle of a phase change form which is performed in an RF stage using the phase shifter according to an embodiment of the present disclosure.

FIG. 20 is a concept view for describing a transmission signal channel of 32T32R and a phase shift form in the antenna apparatus according to an embodiment of the present disclosure.

### DESCRIPTION OF REFERENCE NUMERALS

P: support pole P. C: clamping part
100: antenna apparatus 110: antenna housing part
120: radome panel 210: RF filter
310: antenna board assembly 310A: reflecting panel
310B: rear panel 310C: front panel
311B: rear feed strip line 311C: front feed strip line
350: antenna sub-array 350′: additional antenna sub-array
500: phase shifter 510: phase shift driving motor
520: horizontal mounting bar 530: vertical mounting bar
540: moving substrate part 550: fixed substrate part
590: front horizontal moving bar

### BEST MODEL

Hereinafter, a phase shifter and the antenna apparatus including the same according to embodiments of the present disclosure are described in detail with reference to the accompanying drawings.

In adding reference numerals to the components of each drawing, it should be noted that the same components have the same reference numerals as much as possible even if they are displayed in different drawings. Furthermore, in describing embodiments of the present disclosure, when it is determined that a detailed description of the related well-known configuration or function hinders understanding of an embodiment of the present disclosure, the detailed description thereof will be omitted.

In describing components of an embodiment of the present disclosure, terms, such as a first, a second, A, B, (a), and (b), may be used. Such terms are used only to distinguish one component from another component, and the essence, order, or sequence of a corresponding component is not limited by the terms. All terms used herein, including technical or scientific terms, have the same meanings as those commonly understood by a person having ordinary knowledge in the art to which the present disclosure pertains, unless defined otherwise in the specification. Terms, as those commonly used and defined in dictionaries, should be construed as having the same meanings as those in the context of a related technology, and are not construed as having ideal or excessively formal meanings unless explicitly defined otherwise in the specification.

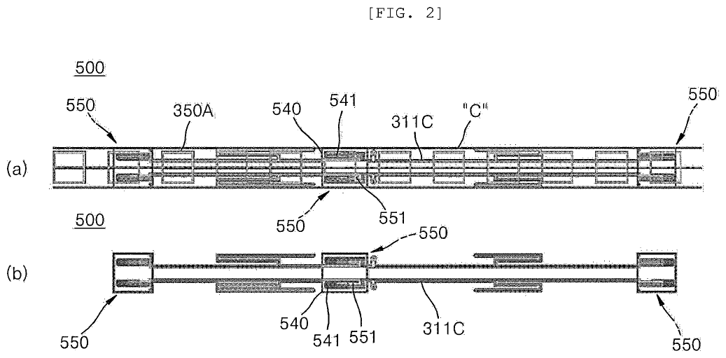

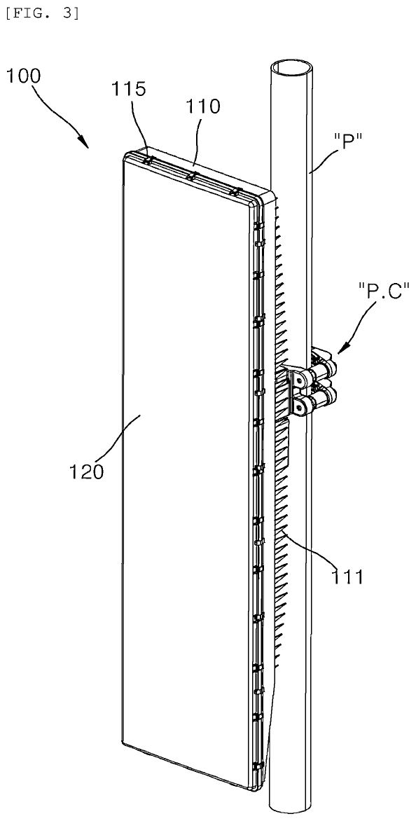

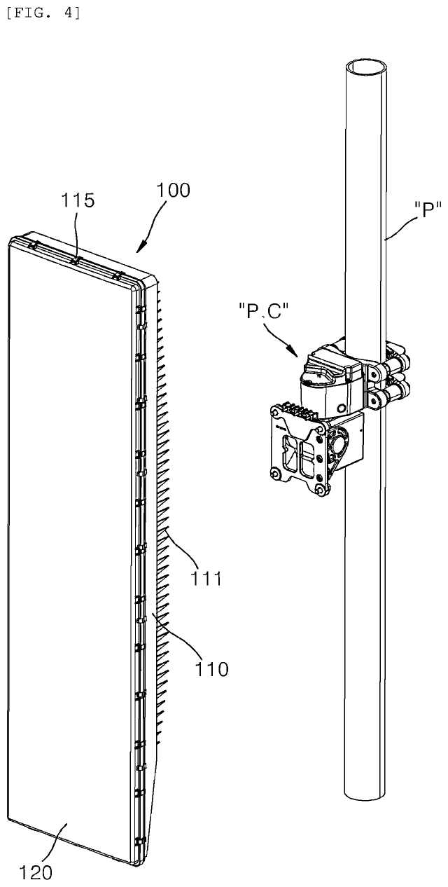

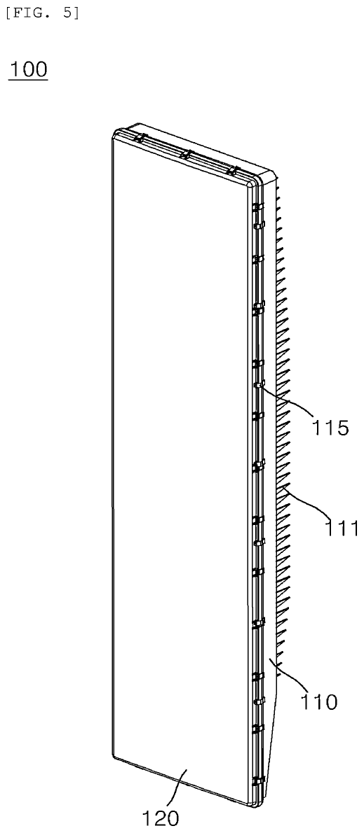

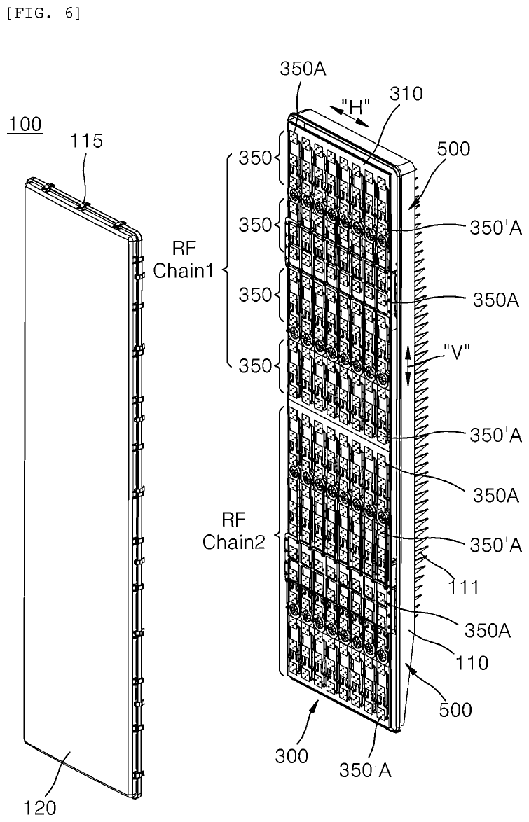

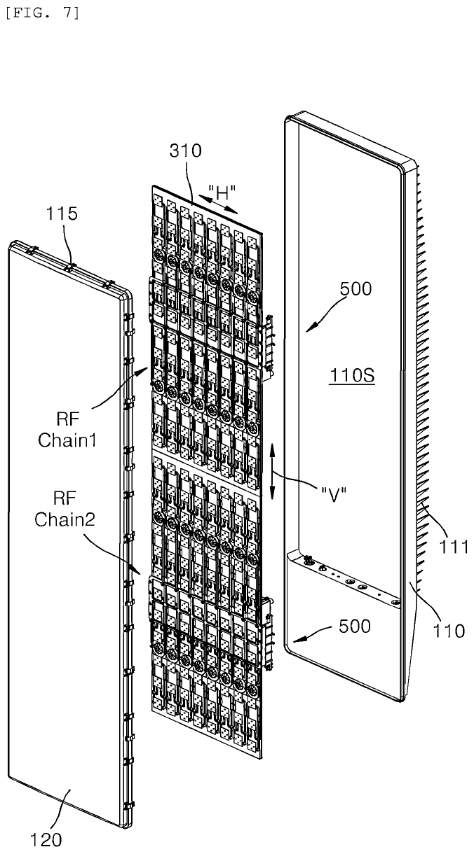

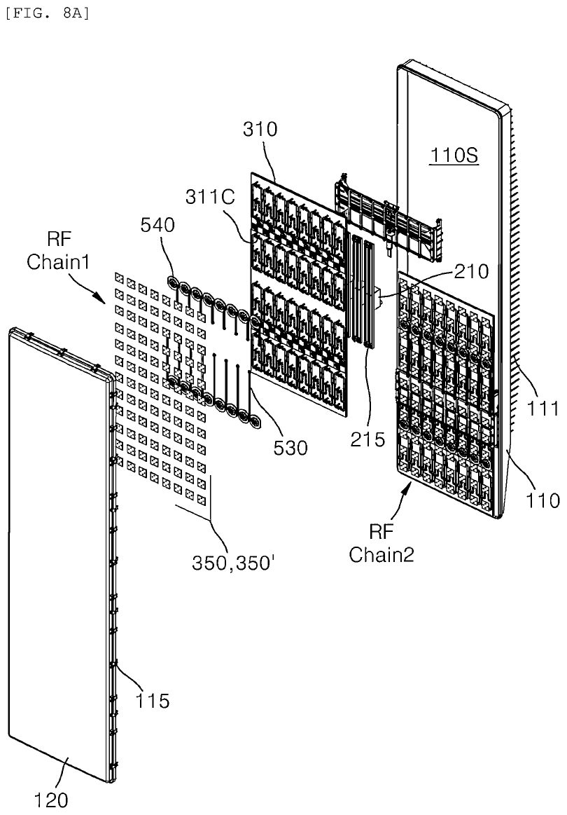

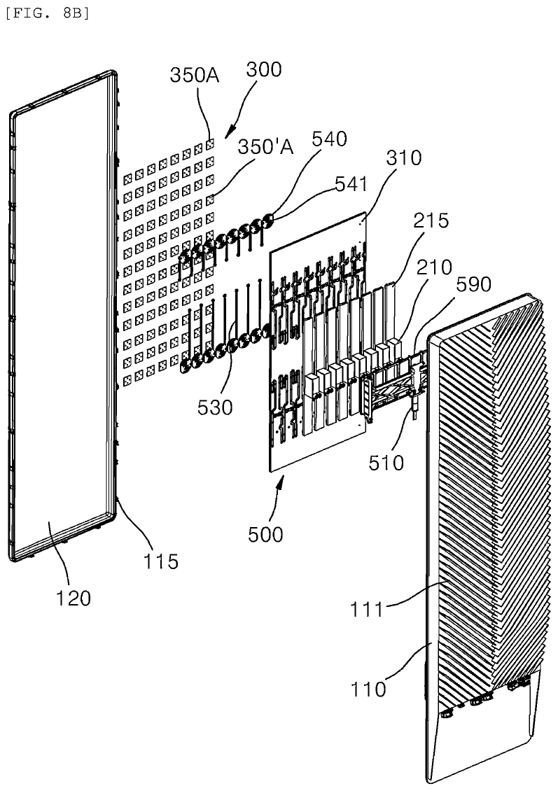

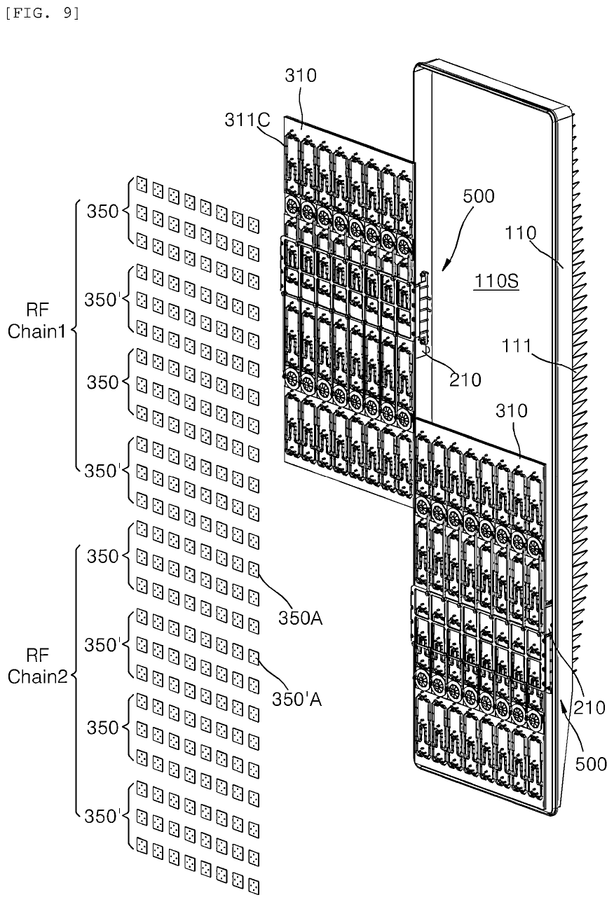

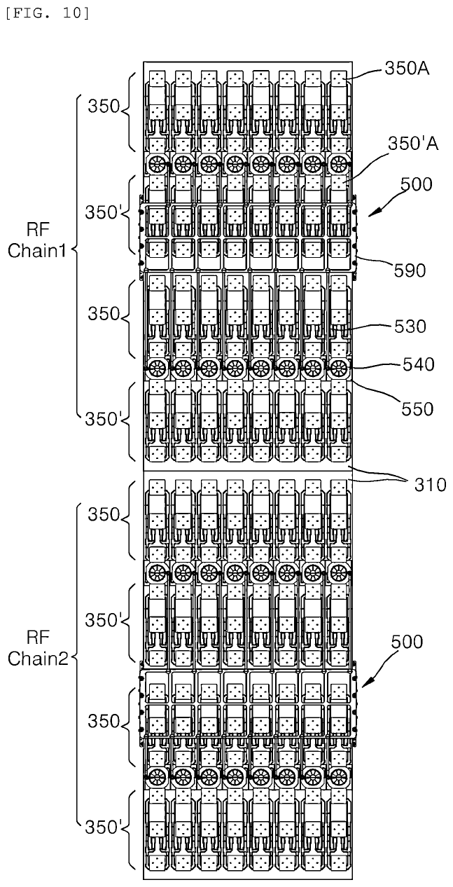

FIG. 2 is a concept view including a common circuit diagram of a phase shifter according to an embodiment of the present disclosure. FIG. 3 is a perspective view illustrating a form in which an antenna apparatus according to an embodiment of the present disclosure has been installed in a support pole. FIG. 4 is an exploded perspective view of FIG. 3. FIG. 5 is a perspective view illustrating an appearance of a phase shifter and an antenna apparatus including the same according to embodiments of the present disclosure. FIG. 6 is an exploded perspective view of the state in which a radome panel, among the components of FIG. 5, has been separated. FIG. 7 is an exploded perspective view illustrating the state in which the radome panel and an antenna housing part, among the components of FIG. 5, have been separated. FIGS. 8A and 8B are an exploded perspective views of exploded front part and rear parts of a radiation element module. FIG. 9 is an exploded perspective view illustrating the state in which one RF chain, among the components of FIG. 6, has been separated. FIG. 10 is a front view illustrating the radiation element module of FIG. 8A.

The antenna apparatus according to an embodiment of the present disclosure may be an antenna apparatus into which a multiple input multiple output (MIMO) technology has been incorporated.

The MIMO technology is a technology that significantly increases a data transmission capacity by using multiple antenna sub-arrays, and is a space multiplexing scheme in which a transmitter transmits different data through transmission antennas and a receiver distinguishes between the transmission data through proper signal processing. Accordingly, as both the numbers of transmission and reception antennas are increased, more data can be transmitted because a channel capacity is increased. For example, if the number of antennas is increased to 10, a channel capacity that is about 10 times compared to a single antenna system is secured by using the same frequency band.

In particular, TRX modules (not illustrated) that perform transmitter and receiver functions may be vertically (V)-horizontally (H) arranged in an up and down vertical direction and a left and right horizontal direction and multiple antenna elements 350 electrically connected to each TRx modules may be arrayed in the antenna apparatus. In this case, a channel capacity constructed in each TRx module may be redefined as an “RF chain”. The multiple antenna elements 350 may be redefined as an “antenna sub-array 350” as a group unit of the antenna elements 350 arranged for antenna beamforming. Hereinafter, the term “TRx module” may be interchangeably used as the same meaning as the “RF chain”. The definition of the array of the antenna elements 350 that construct RF communication for each RF chain may be basically interchangeably used with a term an “antenna sub-array”.

As referred to in FIGS. 3 and 4, an antenna apparatus 100 including a phase shifter according to an embodiment of the present disclosure may be installed in a support pole P that is installed orthogonally to an installation bottom surface through the medium of a clamping part P.C.

The clamping part P.C may perform a function for adjusting the directivity of the antenna apparatus 100 that is provided and installed to be capable of tilting rotation and/or steering rotation with respect to the support pole P, in addition to simply mediating the installation of the antenna apparatus 100 according to an embodiment of the present disclosure.

Meanwhile, as referred to in FIG. 2, the antenna apparatus according to an embodiment of the present disclosure may include a phase shifter (hereinafter referred to as a “phase shifter”).

The phase shifter may include a fixed substrate part 550 including a front feed strip line 311C disposed in front of an antenna board assembly (refer to reference numeral “310” described later) and a moving substrate part 540 that is moved in a predetermined portion of a column C in the direction in which the antenna sub-array 350 and an additional antenna sub-array 350′ described later are arranged in front of the fixed substrate part 550.

In this case, a variable contact point pattern 551 that changes a physical transmission length from the input stage of a feed signal that is supplied from the front feed strip line 311C and a rear feed strip line 311B to the first polarized side and second polarized side of each antenna element for dual polarization beamforming may be formed in the fixed substrate part 550.

However, the single variable contact point pattern 551 that is connected to the input stage (a reference numeral not assigned) of the front feed strip line 311C may be formed to be branched into multiple variable contact point patterns from the input stage of the front feed strip line 311C so that the multiple variable contact point patterns are brought into contact with multiple places by an electrical conduction terminal pattern formed on a back surface of the moving substrate part described later.

For example, both the output stages of the front feed strip line 311C may be connected to one antenna element 350, 350′ so that one polarization (+45 degrees) and the other polarization (−45 degrees) are generated. Likewise, both other output stages that are branched and that change the physical transmission length may also be connected to the other antenna element 350, 350′ that is arranged along the column C. In this case, the antenna elements 350 and 350′ may be formed so that phase differences by the antenna sub-array 350 and the additional antenna sub-array 350′ have the same phase difference value.

Meanwhile, an electrical conduction terminal pattern 541 may be formed on the back surface of the moving substrate part 540. The electrical conduction terminal pattern may be brought into contact with the variable contact point pattern 551 disposed on a front surface of the fixed substrate part 550, thereby changing the physical transmission length. In an embodiment of the present disclosure, the moving substrate part 540 has been illustrated and described as being provided in a variable switch panel type in which the moving substrate part is rotated to electrically conduct the variable contact point pattern 541 that is provided approximately in a circular shape, but is not essentially limited thereto. The moving substrate part may be provided in a straight-line moving body type in which the moving substrate part is movable in a length direction thereof along the column C.

One variable contact point pattern 541 may be disposed in a portion related to the antenna sub-array 350, among antenna elements that are lengthily arranged approximately in the length direction of the column C and one variable contact point pattern may be disposed in a portion related to the additional antenna sub-array 350′, among the antenna elements. The front feed strip line 311C may be connected to the branch stage of the variable contact point pattern 551 of the fixed substrate part 550 that is branched from each input stage of the rear feed strip line 311B, and may have an output stage branched and formed to be connected to the antenna elements 350 and 350′ of the antenna sub-array 350 and the additional antenna sub-array 350′.

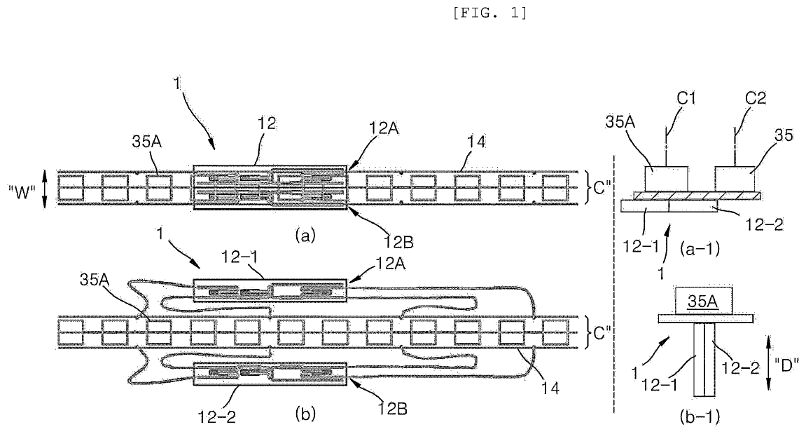

In this case, in a conventional phase shifter, a component corresponding to a front feed strip line functioning as the variable contact point pattern is provided in the moving substrate part (refer to reference numeral “12” in FIG. 1), and a component corresponding to the electrical conduction terminal pattern is provided in the fixed substrate part. In contrast, a core component in the present disclosure is that an installation position of the phase shifter is reversed.

More specifically, the electrical conduction terminal pattern 541 may be disposed in the moving substrate part 540 without a concern of interference between the column C and an adjacent column C (e.g., C1 and C2 in FIG. 1) because the range of the width in which the electrical conduction terminal pattern will be formed is relatively narrow compared to the variable contact point pattern 551 or the front feed strip line 311C disposed in the fixed substrate part 550 on the basis of the column C.

Furthermore, the front feed strip line 311C and the variable contact point pattern 541 the length of each transmission line of which is physically changed depending on the contact point of the electrical conduction terminal pattern 541 have only to be disposed so that the front feed strip line and the variable contact point pattern do not overlap from each branch point to the output stage. Accordingly, the front feed strip line and the variable contact point pattern may have a sufficient arrangement width within a limit in which the front feed strip line and the variable contact point pattern do not interfere with each other with respect to an separation distance between the antenna elements 350 and 350′ that are disposed at an Interval of a Half Wavelength (½λ) Between Adjacent columns C.

In this case, the moving substrate part 540 in which the electrical conduction terminal pattern 541 has been formed is provided at a portion in which the variable contact point pattern 551 has been formed in a plural number so that the multiple moving substrate parts correspond to the portions, respectively. The moving substrate parts 540 may be provided to be simultaneously moved by the driving of a phase shift driving motor 510.

More specifically, as referred to in FIGS. 6 and 7, two RF chains may be constructed in a V direction. In this case, two antenna sub-arrays 350 may be arrayed for each RF chain in the V direction.

Furthermore, the additional antenna sub-array 350′ having the same specification and the same number as the antenna sub-array 350 may be further arrayed in each RF chain.

In this case, each RF chain is constructed through a transmission line that is provided to be branched from one input stage to two output stages. In this case, the antenna sub-array 350 may be connected to any one of the two output stages, and the additional antenna sub-array 350′ may be further arrayed in the other of the two output stages.

Accordingly, a total of 24 antenna sub-arrays 350 and 24 additional antenna sub-arrays 350′ may be arrayed in the V direction.

As described above, a total of 24 antenna elements 350 are arranged in the V direction without the distinction of the names of the antenna sub-array 350 and the additional antenna sub-array 350′. If the phase shifter 500 described later is not provided, as already described with reference to FIG. 1, in general, the antenna sub-arrays have a meaning as an antenna apparatus that embodies the transmission signal channel (i.e., a total of four RF chains) of 64T64R.

However, in an embodiment of the present disclosure, after the transmission line is constructed so that the transmission line is branched from one input stage to two output stages, the antenna sub-array 350 and the additional antenna sub-array 350′ are provided at portions corresponding to the output stages, respectively. TWO RF chains may be embodied depending on phase shifts at two places of the transmission lines by the phase shifter 500.

That is, as referred to in FIGS. 6 to 10, the antenna apparatus 100 according to an embodiment of the present disclosure includes radiation element module 300 that is provided to be electrically connected in front of an RF filter 210 and that includes the multiple antenna sub-arrays 350 and additional antenna sub-arrays 350′ arranged to embody antenna beamforming, and the phase shifter 500 that shifts a phase value by changing the length ratio of the physical transmission lines of the multiple antenna sub-arrays 350 and the multiple additional antenna sub-arrays 350′ at a predetermined ratio.

In this case, the radiation beams of the antenna sub-arrays 350 and the additional antenna sub-arrays 350′ that radiate beams at the phase value shifted by the phase shifter 500 can embody beamforming having an improved gain of +3 dB, compared to a case in which a beam is radiated through an antenna sub-array for each RF chain without being branched from the input stage of a conventional each RF chain to two output stages.

That is, the radiation beams of the antenna sub-arrays 350 and the additional antenna sub-arrays 350′ that radiate beams at the phase value shifted by the phase shifter 500 can embody performance of an antenna apparatus having an improved gain of +3 dB, compared to an antenna apparatus having the same number of RF chains.

In the antenna apparatus 100 according to an embodiment of the present disclosure, the additional antenna sub-array 350′ may be further arrayed in the radiation element module 300 in the V direction along with the multiple antenna sub-arrays 350 arranged to embody predetermined antenna beamforming for each of RF chains having a predetermined number, which are provided to embody a transmission signal channel of 32T32R.

In this case, the phase shifter 500 may be interpreted as having the aforementioned improved gain by radiating a beam by differently shifting the phase value of multiple array antenna elements 350A and additional array antenna elements 350′A of each RF chain.

This is the same as that the transmission signal channel of 32T32R is embodied by applying a unique phase shift method of the present disclosure by adding the phase shifter 500, but a high-specification antenna apparatus provided to embody the transmission signal channel of 64T64R, in general, without including the phase shifter 500 is made to radiate an antenna beam having an improved gain. However, in this case, the phase shift values need to embody a linear distribution with respect to the same reference phase surface by designing the transmission line so that the transmission line is constructed to be branched into the two output stages with respect to the input stage of each RF chain, a No. 1 phase is shifted in the transmission line before being branched into the two output stages by the phase shifter 500, and the No. 1 phase is shifted in any one transmission line, among the transmission lines connected to the two output stages after the branch.

In this case, in a MIMO antenna apparatus for mobile communication, in general, the multiple antenna sub-arrays 350 are designed as a plurality of dual polarization antenna module arrays in order to reduce a fading effect attributable to a multi-path and to perform a polarization diversity function.

More specifically, as referred to in FIGS. 3 to 9, the antenna apparatus 100 according to an embodiment of the present disclosure may include an antenna housing part 110 that forms an appearance of the left, right, side, and rear sides of the entire product and a radome panel 120 that forms an appearance of the front of the entire product, that is provided to shield an opened front surface of the antenna housing part 110, and that protects internal parts (including the RF filter 210 and the antenna board assembly 310 described later) provided in an internal space of the antenna housing part 110 against the outside. The radome panel 120 may be detachably fixed to the front end of the antenna housing part 110 by multiple coupling clips 115 that are provided along the end thereof.

Furthermore, multiple heat sink pins 111 that are manufactured integrally with or separately from the antenna housing part 110, that receive heat from the inside of the antenna housing part 110, and that discharge system heat through the exchange of heat with outside air may be further provided in the rear part of the antenna housing part 110.

In this case, functions and detailed characteristics of the antenna housing part 110 and the radome panel 120 are less relevant to technical characteristics of an embodiment of the present disclosure, and thus a detailed description thereof is omitted.

The RF filter 210 may be provided as multiple unit RF filter bodies (a reference numeral not assigned) disposed on a front surface of a main board (not illustrated) that is disposed in an internal space 110S of the antenna housing part 110. In this case, the multiple unit RF filter bodies may be disposed to correspond to the number of multiple antenna sub-arrays 350 and additional antenna sub-arrays 350′ described later, which are arranged in an H direction.

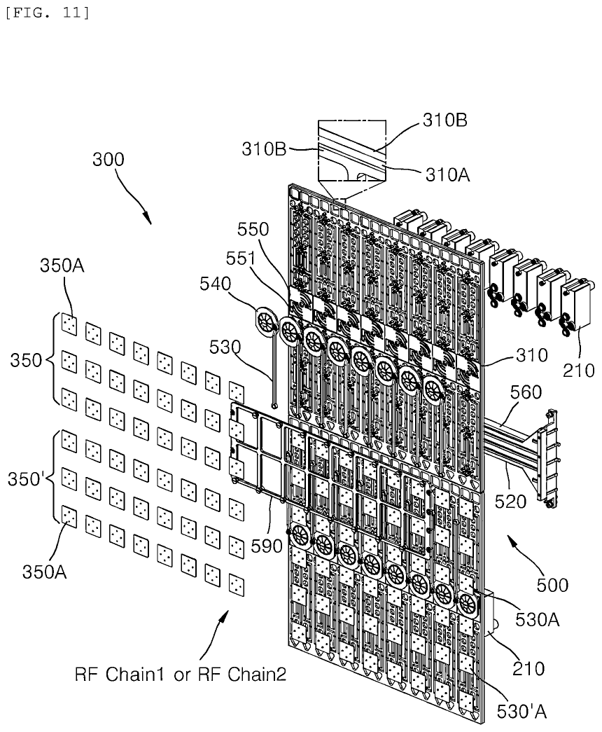

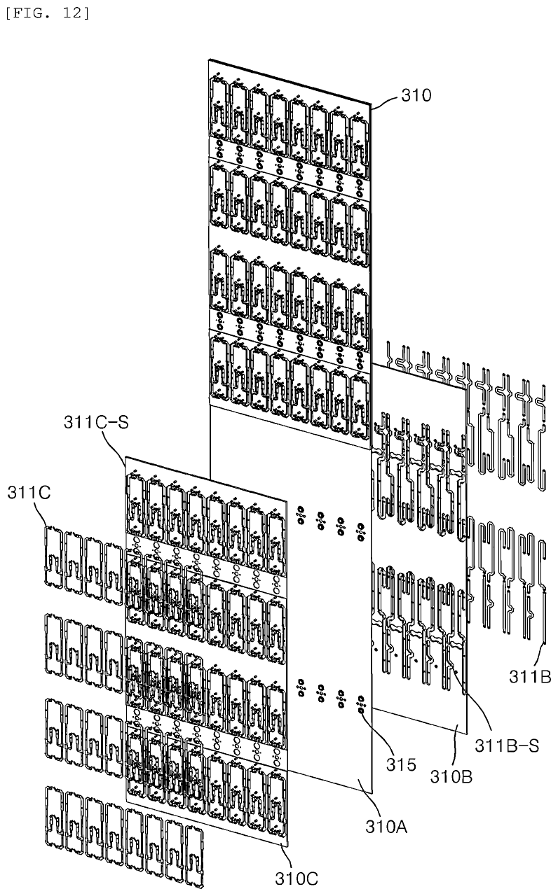

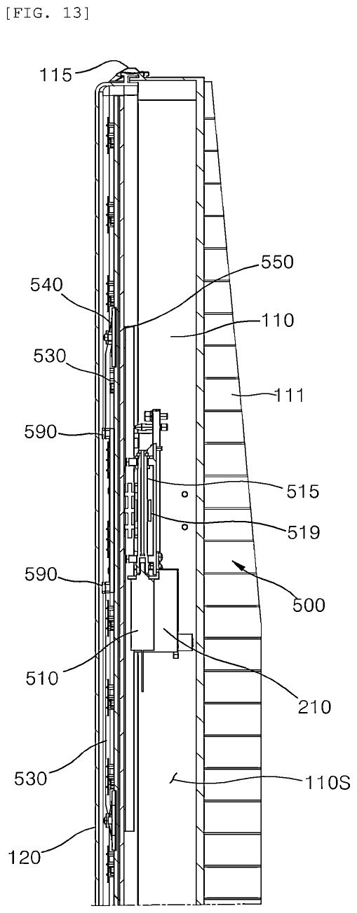

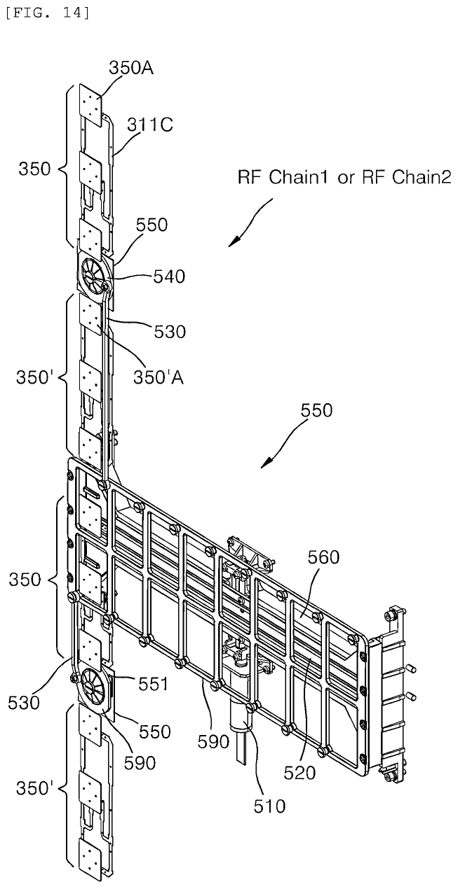

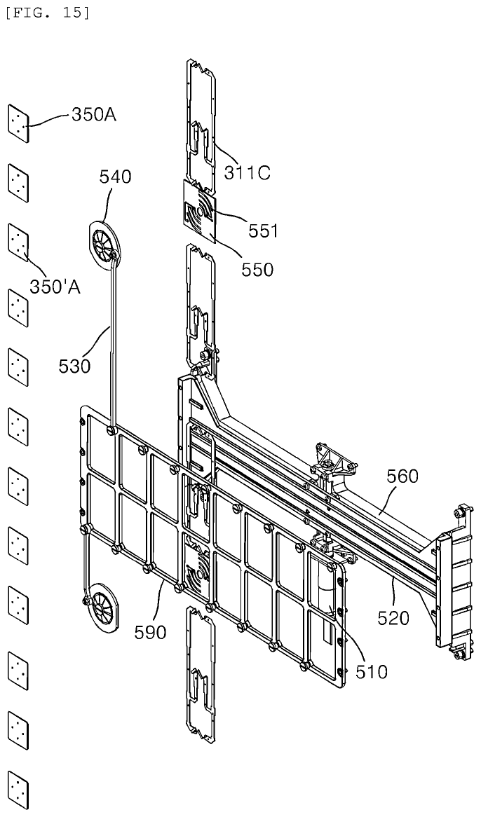

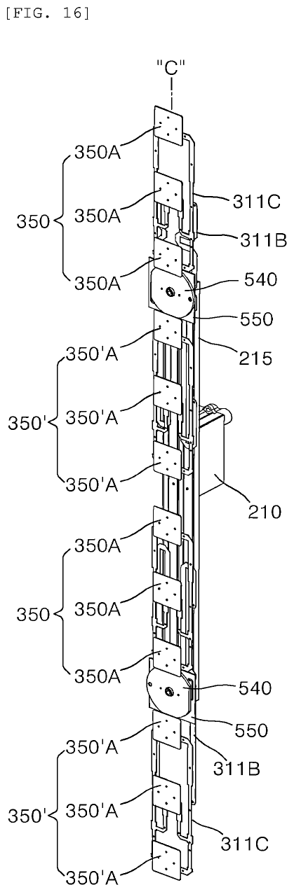

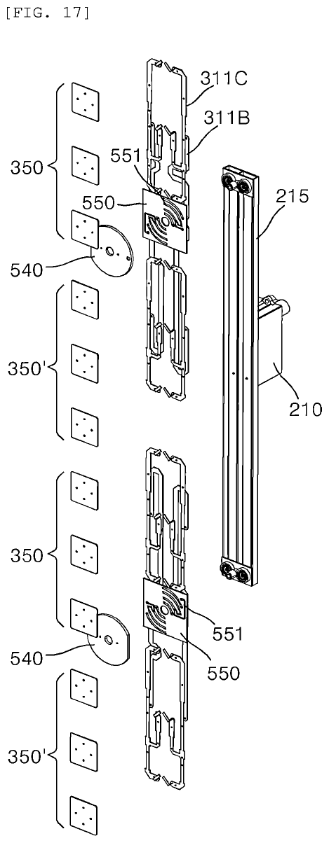

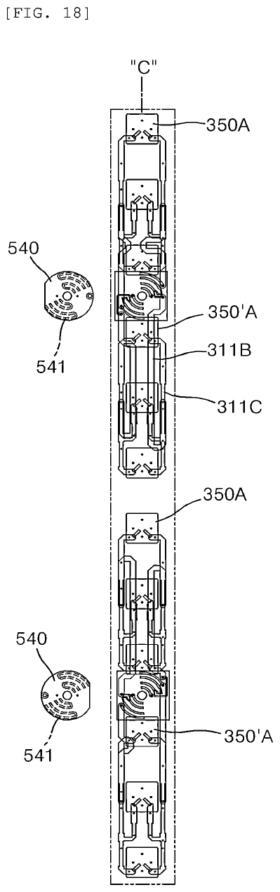

FIG. 11 is an exploded perspective view illustrating the state in which one RF chain included in the radiation element module of FIG. 6 and the phase shifter have been separated. FIG. 12 is an exploded perspective view of an antenna board assembly and a feed strip line combined therewith, among the components of the radiation element module of FIGS. 8A and 8B. FIG. 13 is a cross-sectional view for describing an operation relation of the phase shifter, among the components of the phase shifter and the antenna apparatus including the same according to embodiments of the present disclosure. FIG. 14 is a perspective view illustrating a phase shifter according to an embodiment of the present disclosure. FIG. 15 is an exploded perspective view of FIG. 14. FIG. 16 is a perspective view illustrating a radiation element module of a single column. FIG. 17 is an exploded perspective view of FIG. 16. FIG. 18 is a front view of FIG. 16, and is a front view and partial projection view illustrating the state in which a fixed substrate part and a moving substrate part have been exploded.

As referred to in FIGS. 11 to 18, the antenna apparatus 100 according to an embodiment of the present disclosure may further include the radiation element module 300 that is provided to be electrically connected in front of the RF filter 210 constructed as above and that includes the multiple antenna sub-arrays 350 and additional antenna sub-arrays 350′ that are arranged to embody antenna beamforming.

The radiation element module 300 may include an antenna board assembly 310 by which the multiple antenna sub-arrays 350 and the multiple additional antenna sub-arrays 350′ are fixed so that the multiple antenna sub-arrays and the multiple additional antenna sub-arrays are V-H arranged on a front surface thereof.

In this case, as referred to in FIG. 12, the antenna board assembly 310 may include a reflecting panel 310A provided to forward reflect antenna beams radiated from the multiple antenna sub-arrays 350 and the multiple additional antenna sub-arrays 350′ and a rear panel 310B and a front panel 310C that are stacked and combined with the back surface and front surface of the reflecting panel 310A.

It is preferred that the reflecting panel 310A is provided as an electromagnetic wave shielding material that does not transmit an antenna beam. It is preferred that the rear panel 310B and the front panel 310C provided on the back surface and front surface of the reflecting panel 310A are provided as a plastic resin material which may be easily manufactured by being integrated with the reflecting panel 310A by a molding method as a nonconductive material.

More specifically, the reflecting panel 310A is provided as a heterogeneous material different from the material that constitutes the rear panel 310B and the front panel 310C, and may be provided as a plastic resin material which may be easily manufactured by integrating the rear panel 310B and the front panel 310C with the reflecting panel 310A by a dual injection method.

For reference, the antenna board assembly 310 may be provided in a PCB form as a common PCB material (e.g., an FR4 material). A feed line (a transmission line, a component corresponding to the feed strip line of the present disclosure described later) may be printed and formed on a front surface or back surface of the PCB by a patterning and printing method.

However, if the feed line is printed and formed on the front surface or back surface of the PCB by the patterning and printing method, there is a problem in that an insertion loss is increased because the feed line is directly formed in a dielectric layer having a predetermined dielectric constant.

Therefore, in the antenna apparatus according to an embodiment of the present disclosure, as referred to in FIG. 12, the radiation element module 300 may further include the multiple rear feed strip lines 311B and the multiple front feed strip lines 311C that are disposed in any one of strip line installation slits 311B-S and 311C-S processed in the rear panel 310B and the front panel 310C in a slit shape and that are made of a conductive material arranged for an electrical connection with the RF filter 210.

That is, in an embodiment of the present disclosure, at least the front feed strip line 311C may be provided in a terminal strip form in which the front feed strip line is fixed to the antenna board assembly 310 provided as a non-conductive material.

In an embodiment of the present disclosure, the front feed strip line 311C that performs substantially a feed transmission line function has been illustrated and described as being composed in the air strip type, but is not essentially limited thereto. The front feed strip line may be formed in a PCB type in which the front feed strip line is patterned and printed on one surface of a common PCB.

In this case, the strip line installation slits 311B-S and 311C-S may be formed in the antenna board assembly 310 in a way to penetrate therethrough in forward and backward directions thereof so that the rear feed strip line 311B and the front feed strip line 311C are accommodated in the strip line installation slits through the medium of an air layer.

Meanwhile, as referred to in FIGS. 11 to 15, the antenna apparatus 100 according to an embodiment of the present disclosure may further include the phase shifter 500 that embodies a desired phase shift value by physically changing the length of the transmission lines of the feed strip lines 311B and 311C that are connected from the RF filter 210 to the multiple antenna sub-arrays 350 and the multiple additional antenna sub-arrays 350′ so that a phase is changed at a predetermined value with respect to the same reference phase surface.

The phase shifter 500 may include a phase shift driving motor 510 fixed between unit RF filter bodies on the back side of the antenna board assembly 310, a horizontal mounting bar 520 that horizontally moves in up and down directions on the back side of the antenna board assembly 310 in the rotation direction of the motor shaft of the phase shift driving motor 510, a front horizontal moving bar 590 that is connected to the left and right side ends of the horizontal mounting bar 520 by avoiding the left and right side ends of the antenna board assembly 310 and that is moved in up and down directions on the front surface of the antenna board assembly 310 while operating in conjunction with the horizontal mounting bar 520, vertical mounting bar 530 having one end connected to the front horizontal moving bar 590 and the other end hinged and connected to the variable switch panel 540 described later, and the moving substrate part 540 that is rotatably provided on the front surface of the fixed substrate part 550 fixed to the front surface of the front panel 310C of the antenna board assembly 310.

In this case, as referred to in FIGS. 14 and 15, the horizontal mounting bar 520 may be connected to the left and right ends of the front moving horizontal bar 590, respectively, which is moved in up and down directions while maintaining left and right horizontality on the back side of the antenna board assembly 310 and moved in up and down directions while maintaining left and right horizontality on the front side of the antenna board assembly 310 through the outside parts of the left and right ends of the antenna board assembly 310.

Furthermore, as referred to in FIGS. 14 and 15, the phase shift driving motor 510 is disposed in the horizontal mounting bar 520 so that the phase shift driving motor has a motor rotation shaft in up and down directions. A rotation screw pole 515 may be axially combined with the motor rotation shaft of the phase shift driving motor 510 so that the rotation screw pole is rotatably provided on one side or the other side thereof.

In this case, the phase shift driving motor 510 is in the state in which the phase shift driving motor has been fixed within the antenna housing part 110. When the rotation screw pole 515 is geared with a female thread of a screw pole through hole (a reference numeral not assigned) provided in a screw guide mounting block (a reference numeral not assigned), the screw guide mounting block moves the horizontal mounting bar 520 up and down directions while being moved in up and down directions.

As referred to in FIGS. 14 and 15, as the phase shift driving motor 510 of the phase shifter 500 including the aforementioned components electrically operate, when the rotation screw pole 515 is rotated to one side or the other side thereof, the screw guide mounting block is moved upward or downward in the rotation direction of the rotation screw pole 515, the horizontal mounting bar 520 to which the screw guide mounting block has been fixed and the front moving horizontal bar 590 fixed to the horizontal mounting bar 520 are moved while maintaining left and right horizontality upward or downward, and the moving substrate part 540 combined with the end of the multiple vertical mounting bars 530 is rotated as the multiple vertical mounting bars 530 are moved in up and down directions at the same time. Accordingly, a phase shift value through the variable contact point pattern 551 of the fixed substrate part 550 and a change in the physical transmission length of the front feed strip line 311C can be embodied.

The fixed substrate part 550 is a kind of PCB. A variable circuit as a variable contact point pattern 551 having at least one power cut point at which the phase of a frequency through the transmission line may be printed by patterning the variable circuit on the front surface of the fixed substrate part. The at least one electrical conduction terminal pattern 541 that electrically conducts the power cut point of the variable contact point pattern 551 may be formed by printing the at least one electrical conduction terminal pattern on the back surface of the moving substrate part 540.

In this case, the moving substrate part 540 is provided to be always elastically supported on the front side of the fixed substrate part 550 through the medium of an elastic member (a reference numeral not assigned) provided as a leaf spring. The elastic member may be elastically supported toward the moving substrate part 540 by being hinged and fixed by a hinge panel (a reference numeral not assigned).

Referring to FIG. 12, the reflecting panel 310A is provided in the panel type provided as a material capable of shielding electromagnetic waves as described above. The front panel 310C is stacked and disposed on the front surface of the reflecting panel. The fixed substrate part 550, among the components of the phase shifter 500, may be fixed to a front surface of the front panel 310C.

Meanwhile, as referred to in FIG. 12, the antenna apparatus 100 according to an embodiment of the present disclosure may further include a low passband filter (LPF) 215 connected to the output port (not illustrated) of the unit RF filter body and connected to the input stages (a reference numeral not assigned) of the multiple feed strip lines 311B and 311C.

The LPF 215 is a filter for removing high frequency noise, and may have the top and the bottom provided to be connected to input stage portions of the feed strip lines 311B and 311C, respectively.

Meanwhile, multiple ground washers (a reference numeral not assigned) are disposed on the front surface of the reflecting panel 310A in a pair unit, and may perform a ground function.

The antenna apparatus 100 constructed as described above according to an embodiment of the present disclosure can create an advantage in that an insertion loss can be minimized because the rear panel 310B and the front panel 310C each made of a plastic resin material are integrated and formed on the back surface and front surface of the antenna board assembly 310 on the basis of the reflecting panel 310A by excluding a PCB made of a common PCB material compared to a conventional technology, but the feed strip lines 311B and 311C that perform the function of the transmission line are accommodated in the air dielectric layer.

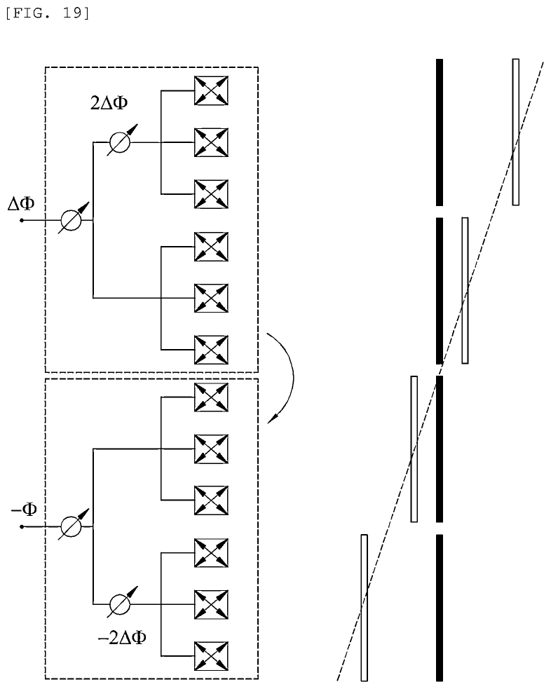

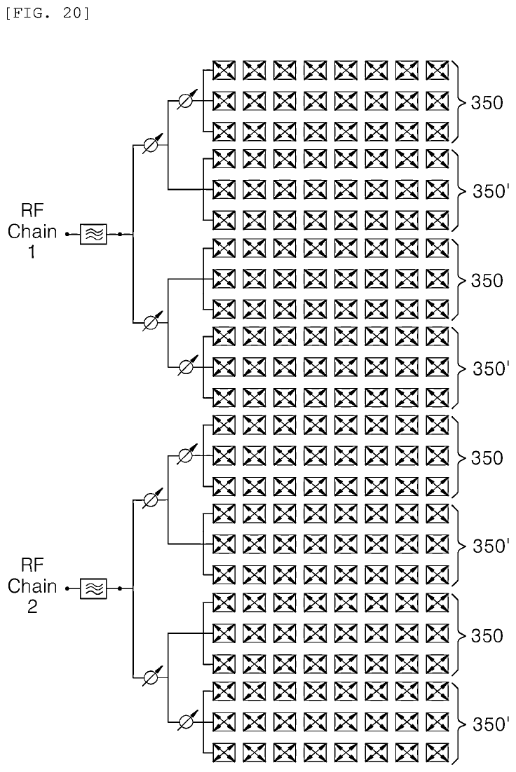

FIG. 19 is a circuit diagram and phase difference diagram for describing the principle of a phase change form which is performed in the RF stage using the phase shifter 500 according to an embodiment of the present disclosure. FIG. 20 is a concept view for describing the transmission signal channel of 32T32R and a phase shift form in the antenna apparatus according to an embodiment of the present disclosure.

In general, if the length of the transmission line is changed in each RF chain, in order to embody a mirror symmetry structure, the phase of a signal that is supplied to at least two antenna sub-arrays 350, among the four antenna sub-arrays 350, requires a support task in a digital stage.

In the antenna apparatus according to an embodiment of the present disclosure, the phase shifter 500 is for omitting the support task in the digital stage. As referred to in FIG. 18, the one-side transmission line and the other-side transmission line may be rotatably provided so that the lengths of the one-side transmission line and the other-side transmission line are varied at a predetermined ratio by a first electrical conduction pattern terminal (a reference numeral not assigned) and second electrical conduction pattern terminal (a reference numeral not assigned) of the variable switch panel 540 at a first power cut point (not illustrated) before a feed signal input from one TRX module (means transceiver elements mounted on the main board or the amplification element part) is branched from each input stage to the two output stages and at a second power cut point (not illustrated) after the feed signal is branched.

Therefore, the physical lengths of the one-side transmission line and the other-side transmission line are changed by the first electrical conduction pattern terminal of the variable switch panel 540 at the first power cut point before the branch from one input stage to the two output stages. Accordingly, a desired phase shift value can be embodied by changing the phase by Δφ and −ΔΦ. The physical length of the other-side transmission line is changed by the second electrical conduction pattern terminal of the variable switch panel 540 at the second power cut point, that is, the transmission line of the output stage after the branch into the two output stages. Accordingly, a desired phase shift value can be embodied by changing the phase by 2ΔΦ and −2ΔΦ.

In this case, the mirror symmetry structure having the most efficient beamforming performance, such as that is referred to in FIG. 8, can be embodied because the phase shift values of the two antenna sub-arrays 350 and the two additional antenna sub-arrays 350′ can form a linear phase distribution on the basis of the same phase surface.

In this case, as referred to in FIG. 19, the antenna apparatus 100 according to an embodiment of the present disclosure embodies beamforming by shifting the phase in order to achieve ratio having a physical length a predetermined ratio at one place of the transmission line before the branch from the input stage of the RF chain to the two output stages and at one place of the transmission line that connects any one of the two output stages after the branch, among the antenna sub-array 350 and the additional antenna sub-arrays 350′ provided to embody total of transmission line channels of 32T32R.

Accordingly, there is an advantage in that a beam having a narrow beam width and a great antenna gain can be radiated a because a gain of +6 dB is improved compared to an antenna apparatus that has two RF chains, but has the transmission line channel of 32T32R not including the phase shifter 500 and a gain of +3 dB is improved compared to an antenna apparatus that has two RF chains and has the phase shifter, but has the transmission line channel of 32T32R that is not branched into two output stages.

Furthermore, the antenna apparatus 100 illustrated in FIG. 20 according to an embodiment of the present disclosure can embody beamforming having the same effect as that of an 64T64R antenna apparatus because the phase can be changed with respect to four antenna sub-arrays for each RF chain, and has advantages in terms of a product cost and a process because the antenna apparatus has two RF chains compared to a 64T64R antenna apparatus having four RF chains.

Technical characteristics in which the antenna elements 350A that embody a predetermined number of transmission channels (e.g., 64T64R) are disposed without separately distinguishing between the antenna sub-array 350 and the additional antenna sub-array 350′ and the antenna apparatus 100 described with reference to FIGS. 2 to 20 according to an embodiment of the present disclosure is operated so that the use specifications thereof are reduced by one step through the phase shifter 500, but is embodied to have a higher antenna gain and a beamforming effect have been described.

If the same principle as that of the antenna apparatus 100 according to an embodiment of the present disclosure is applied, for example, if the antenna sub-arrays 350 and the additional antenna sub-arrays 350′ are arranged so that two RF chains are constructed substantially in the V direction, one RF chain is embodied because an antenna beam is radiated by changing the phase at a desired phase shift value by the phase shifter 500. Accordingly, a transmission signal channel of 16T16R can be embodied.

The phase shifter and the antenna apparatus including the same according to embodiments of the present disclosure have been described above in detail with reference to the accompanying drawings. However, an embodiment of the present disclosure is not essentially limited to the aforementioned embodiment, and may include various modifications and implementations within an equivalent range thereof by a person having ordinary knowledge in the art to which the present disclosure pertains. Accordingly, the true range of a right of the present disclosure will be said to be defined by the appended claims.

### INDUSTRIAL APPLICABILITY

The present disclosure provides the phase shifter and the antenna apparatus including the same, which do not increase an installation space in the depth direction of the antenna apparatus, can be manufactured in various manufacturing ways, can improve the gain of an antenna, and can minimize interference between the beams of the columns of radiation elements because a beam having a narrower width can be radiated.

1. A phase shifter comprising:
a front feed strip line branched to enable a beam output of dual polarization and electrically connected to multiple radiation element modules that form multiple antenna sub-arrays and multiple additional antenna sub-arrays and that are disposed on a front surface of an antenna board assembly;
a fixed substrate part disposed on the front surface of the antenna board assembly and comprising a variable contact point pattern that connects a branch point of the front feed strip line and that changes a physical transmission length toward a first polarized side and second polarized side of the radiation element module; and
a moving substrate part in which an electrical conduction terminal pattern that is brought into contact with the variable contact point pattern of the fixed substrate part while being moved has been formed.

2. The phase shifter of claim 1, wherein:
the multiple fixed substrate parts are provided to be spaced apart from each other in one column in which the multiple antenna sub-arrays and the multiple additional antenna sub-arrays are formed on the front surface of the antenna board assembly in up and down directions, and
the moving substrate part is provided to have a number corresponding to the fixed substrate parts.

3. The phase shifter of claim 1, wherein the front feed strip line and the variable contact point pattern of the fixed substrate part are fixed to the antenna board assembly.

4. The phase shifter of claim 1, wherein the front feed strip line is formed separately from the fixed substrate part and is formed on the front surface of the antenna board assembly made of a PCB material by patterning and printing the front feed strip line.

5. The phase shifter of claim 1, wherein:
the fixed substrate part is provided in a PCB form in which the fixed substrate part is made of a PCB material different from that of the antenna board assembly, and
the variable contact point pattern is formed on a front surface of the fixed substrate part provided in the PCB form by patterning and printing the variable contact point pattern.

6. The phase shifter of claim 1, wherein:
the antenna board assembly comprises a reflecting panel configured to forward reflect antenna beams radiated from the multiple antenna sub-arrays and the multiple additional antenna sub-arrays, a rear panel stacked and combined with a back surface of the reflecting panel, and a front panel stacked and combined with a front surface of the reflecting panel, and
the front feed strip line is provided in a terminal strip form in which the front feed strip line is fixed to the front panel of the antenna board assembly, which is made of a non-conductive material.

7. The phase shifter of claim 6, wherein the front feed strip line is arranged in a strip line installation slit processed in the front panel in a slit shape.

8. The phase shifter of claim 1, wherein:
the radiation element module is provided to be electrically connected to a front of the RF filter,
the multiple antenna sub-arrays and the multiple additional antenna sub-arrays are arranged to embody antenna beamforming by constructing a predetermined number of RF chains, and
a phase value is shifted by changing a length ratio of physical transmission lines of the multiple antenna sub-arrays and the multiple additional antenna sub-arrays at a predetermined ratio.

9. The phase shifter of claim 8, wherein the electrical conduction terminal pattern of the moving substrate part embodies a linear phase distribution according to the predetermined ratio with respect to an identical reference phase surface by radiating beams by differently shifting phase values of the multiple antenna sub-arrays and the additional antenna sub-array in a transmission line that constitutes any one of an input stage of each of the RF chains and the branched two output stages, by an operation of being moved and brought into contact with the variable contact point pattern of the fixed substrate part.

10. An antenna apparatus comprising the phase shifter of claim 1.
